(19) United States
(12) Patent Application Publication
(10) Pub. No.: US 2019/0362300 A1
(43) Pub. Date: Nov. 28, 2019

(54) Method For Locating Electronic Shelf Labels In A Retail Area

(71) Applicant: SES-imagotag, Nanterre (FR)

(72) Inventors: Philippe Bottine, Boulogne-Billancourt (FR); François Robin, Paris (FR)

(73) Assignee: SES-imagotag, Nanterre (FR)

(21) Appl. No.: 16/331,781

(22) PCT Filed: Sep. 8, 2017
(86) PCT No.: PCT/EP2017/072660

§ 371 Date: Mar. 8, 2019

(30) Foreign Application Priority Data
Sep. 9, 2016 (FR) 1658422

(51) Int. Cl. G06Q 10/08; H04B 10/116; H04W 4/35; H04W 4/80

(52) U.S. Cl. CPC G06Q 10/087; H04W 4/80; H04W 4/35; H04B 10/116

(57) ABSTRACT

The invention relates to a method for locating electronic shelf labels (1) distributed in a retail area, each provided with a label identifier specific thereto, a plurality of radio frequency tags (4) being configured to transmit radio signals (S1), wherein: a mobile terminal (3) receives (S2) radio signals transmitted by a plurality of radio frequency tags (4) and determines data from the signals; at a time of acquisition, the mobile terminal (3) acquires the identifier of an electronic shelf label (1) from said electronic shelf label (1); the mobile terminal (3) transmits, to a central computer server (6), the label identifier and the data from the signals received at the time of acquisition, the central computer server (6) determines the association data between the electronic shelf label (1) identified by the label identifier and a position determined from the data from the radio signals received at the time of acquisition.

### GENERAL TECHNICAL FIELD AND CONTEXT OF THE INVENTION

The present invention relates generally to the management of electronic shelf labels distributed along a rail of a shelf of a sales area. More precisely, it concerns the determination of the distribution of these electronic shelf labels, each of said electronic shelf labels being provided with an identifier specific to said electronic shelf label.

In a sales area, such as in a supermarket, the electronic shelf labels are arranged along rails, said rails being themselves arranged along the outer ends of the shelves of the gondola. The electronic shelf labels are thus visible to the customers of the sales area, and provide them information relating to items situated in the immediate vicinity of these electronic shelf labels. Typically, the items are situated above or immediately below the electronic shelf label associated thereto.

The layout of a sales area is normally described by a planogram. A planogram is a data set of association between items of a sales area and spots of said sales area. The planogram establishes what items should be at which height, on which shelves and on how many linear meters. Preferably, a planogram takes the form of a visual representation of the implantation of a department or shelf in a sales area. It generally corresponds to a department or shelf space viewed from the front, but can also be three dimensionally visible on computer medium.

Ideally, the organization of the sales area and the planogram should be the reflection of one another. Yet, the planograms currently used are theoretical visions of what the sales area should be. Indeed, they are typically defined generically, for a plurality of stores of similar size, for which the same arrangement and the same stock is provided. Then, the arrangement of a given sales area is made based on the theoretical planogram corresponding to the size of the sales area.

In fact, the reality of the organization of the sales area deviates significantly from this theoretical planogram. Indeed, it is common that approximately 10 to 15% of the items present in the sales area are not found on the planogram, for example because these items are specific to the sales area, and have not been integrated into the planogram designed for a set of sales areas. In addition, the arrangement of items in the sales area can vary over time, due to item shifts and adaptations made by the operators of the sales area, for example for seasonal items such as those proposed only in Christmas or at the start of the school year.

As a result, the planogram is never in line with reality, and a location of an electronic shelf label or an item making use of this planogram suffers from the inability of the planogram to reflect reality. But the inaccuracy of the planogram has other disadvantages, particularly in inventory management and other commercial aspects, since the planogram is for example used to estimate the quantities of items on the shelves, based on the theoretical extent of their presence which, when erroneous, can lead to unanticipated inventory shortage.

In the context of sales space management, it is therefore very important to be able to determine the distribution of electronic shelf labels along the rail, and in particular to ensure the correspondence between the distribution of electronic shelf labels and that of the spaces allocated to the respective items associated with said electronic shelf labels.

### PRESENTATION OF THE INVENTION

The present invention aims at determining the distribution of electronic shelf labels of a sales area.

For this purpose, there is provided a method for locating electronic shelf labels in a sales area, said sales area having a plurality of electronic shelf labels distributed in said sales area, each of said electronic shelf labels being associated with an item, each of said electronic shelf labels being provided with a label identifier specific thereto, said sales area comprising a plurality of radiofrequency tags configured to transmit radio signals, said method comprising the steps according to which,
a portable terminal provided with a radiofrequency location module receives radio signals transmitted by a plurality of radiofrequency beacons and determines data derived from the radio signals by means of said radiofrequency location module;
at an acquisition time, the portable terminal acquires the identifier of an electronic shelf label from said electronic shelf label;
the portable terminal transmits to a central computer server the label identifier and the data derived from the signals received at the acquisition time,
the central computer server determines association data between the electronic shelf label identified by the label identifier and one position of said electronic shelf label determined from the data derived from the radio signals received at the acquisition time.

By providing for a determination of the information enabling the location precisely at the acquisition time, the method makes it possible to effectively determine the location of an electronic shelf label in a simple and resource-saving manner. In particular, the fact that it is the portable terminal that both receives radio signals and acquires the label identifier makes it possible to ensure greater accuracy in the location of the electronic shelf label corresponding to the identifier compared to a method in which it would be the portable terminal that would send the radio signals and the radiofrequency beacons that would receive them.

The method according to the invention is advantageously but optionally supplemented by the following features, taken alone or in any of their technically possible combinations:
the portable terminal also acquires an identifier of an item associated with the electronic shelf label and transmits said item identifier to the central computer server as well as the label identifier and the data derived from the radio signals received at the acquisition time, and the central computer server determines association data between the electronic shelf label, the position of the electronic shelf label and the item associated with said electronic shelf label;
each electronic shelf label is provided with a radiofrequency peripheral device and the portable terminal acquires the identifier of the electronic shelf label by establishing a radiofrequency communication with said electronic shelf label;
each electronic shelf label is provided with an element for visually representing the label identifier, and the portable terminal comprises an optical reader adapted to read said visual representation element and acquire the label identifier;
the radiofrequency location module determines the location of the portable terminal from the radio signals transmitted by the radiofrequency beacons by measuring the propagation time of the respective signals of said radiofrequency beacons, and the data derived from the radiofrequency signals are position data;
the location data are position coordinates;
the data derived from the radiofrequency signals are reception time measurements of said signals, and the location of the portable terminal is determined by the central computer server from said time measurements;
the sales area includes a plurality of shelves carrying the electronic shelf labels, said shelves defining aisles therebetween, and radiofrequency beacons are arranged in the extension of aisles of the sales area;
for each of a plurality of aisles, a radiofrequency beacon is arranged on each side of the extension of the aisle;
the radiofrequency beacons emit pulses over a frequency band greater than 500 MHz according to the Ultra wideband technique.

The invention also relates to a method for locating electronic shelf labels in a sales area, said sales area having a plurality of electronic shelf labels distributed in said sales area, each of said electronic shelf labels being associated with an item, each of said electronic shelf labels being provided with a label identifier specific thereto, said sales area comprising a plurality of luminaires configured to transmit light signals,

the expected arrangement of the electronic tags in the sales area being described by a planogram configured to comprise association data between each of a plurality of label identifiers and an expected position within shelves of the sales area,

said method comprising the steps according to which,
a portable terminal equipped with a positioning module receives light signals transmitted by several luminaires and determines data derived from the light signals by means of said positioning module;
at an acquisition time, the portable terminal acquires the identifier of an electronic shelf label from said electronic shelf label;
the portable terminal transmits to a central computer server the label identifier and the data derived from the signals received at the acquisition time,
the central computer server determines the association data in the planogram between the electronic shelf label identified by the label identifier and one position of said electronic shelf label determined from the data derived from the light signals received at the acquisition time, the position thus determined being specific to said electronic shelf label.

The invention also relates to a system for locating electronic shelf labels in a sales area, said sales area having a plurality of electronic shelf labels distributed in said sales area, each of said electronic shelf labels being associated with an item, each of said electronic shelf labels being provided with a label identifier specific thereto,

said system comprising:
a central computer server,
a plurality of radiofrequency beacons configured to transmit radio signals,
a portable terminal provided with a radiofrequency location module configured to receive the radio signals and determine data derived from the radio signals by means of said radiofrequency location module, the portable terminal being further adapted to acquire, at an acquisition time, an identifier of an electronic shelf label from said electronic shelf label, and to transmit to the central computer server the label identifier and the data derived from the signals received at the acquisition time,
   the central computer server being configured to determine association data between the electronic shelf label identified by the label identifier and one position of said electronic shelf label determined from the data derived from the radio signals received at the acquisition time.

Preferably, the system is configured to implement a location method according to the invention.

The invention also relates to a system for locating electronic shelf labels in a sales area, said sales area having a plurality of electronic shelf labels distributed in said sales area, each of said electronic shelf labels being associated with an item, each of said electronic shelf labels being provided with a label identifier specific thereto,

said system comprising:
a central computer server, comprising a planogram configured to comprise association data between each of a plurality of label identifiers and an expected position within shelves of the sales area,
a plurality of luminaires configured to transmit light signals,
a portable terminal equipped with a positioning module configured to receive the light signals and determine data derived from the light signals by means of said positioning module, the portable terminal being further adapted to acquire, at an acquisition time, an identifier of an electronic shelf label from said electronic shelf label, and to transmit, to the central computer server, the label identifier and the data derived from the signals received at the acquisition time,

the central computer server being configured to determine association data in the planogram between the electronic shelf label identified by the label identifier and one position of said electronic shelf label determined from the data derived from the light signals received at the acquisition time, the position thus determined being specific to said electronic shelf label.

Preferably, this system is configured to implement a location method according to the invention.

### PRESENTATION OF THE FIGURES

Other features, objects and advantages of the invention will become more apparent from the following description, which is purely illustrative and non-restrictive, and which should be read with reference to the appended drawings among which:

FIG. 1 schematically shows a system for locating electronic shelf labels according to a possible embodiment of the invention;

FIG. 2 shows a detailed view of the portable terminal of a system for locating electronic shelf labels according to a possible embodiment of the invention;

FIG. 3 is a diagram illustrating steps implemented in a method for locating electronic shelf labels according to a possible embodiment of the invention.

### DETAILED DESCRIPTION

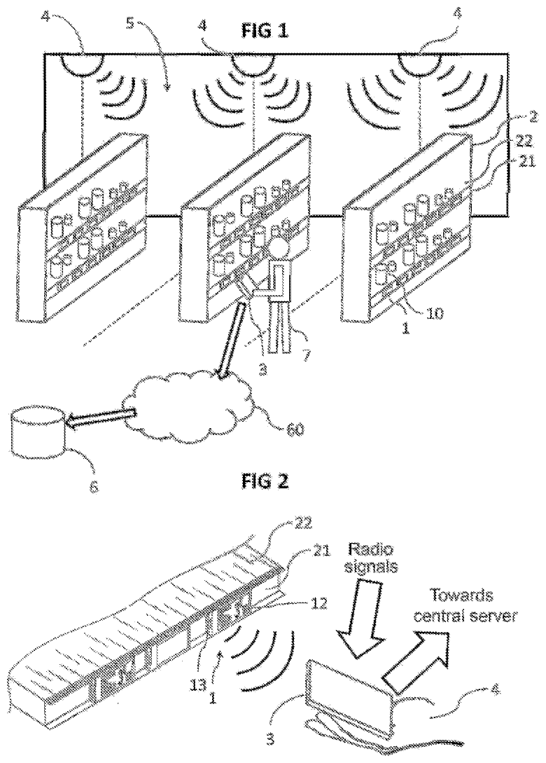

FIGS. 1 and 2 show an example of a system for locating electronic shelf labels in a sales area. As indicated above, the sales area has a plurality of electronic shelf labels 1 distributed in said sales area, typically at the level of rails 21 extending along the shelves 22 of the gondola 2. The electronic shelf labels 1 are thus visible to the customers of the sales area, and make accessible for them information relating to items 10 situated in the immediate vicinity of these tags. Typically, items 10 are situated above or immediately below the electronic shelf label 1 associated thereto. Each of the electronic shelf labels 1 is provided with a label identifier specific thereto, typically a set of alphanumeric symbols.

Generally, an electronic shelf label 1 includes a display screen 12 for displaying information relating to an item 10 with which it is associated. Typically, this information comprises the price of the item 10, and other information usually available in a sales area, for example the price per kilogram for a food item.

In particular, the electronic shelf label 1 includes a radiofrequency communication module for receiving data representative of information relating to an item 10 coming from a central station, a memory for storing said data, and a microcontroller for controlling the display of information relating to the item 10.

Preferably, the electronic shelf label 1 also includes a radiofrequency peripheral device for communication with a portable terminal. The radiofrequency peripheral device of the electronic shelf label 1 may for example comprise an antenna and an NFC-type (Near Field Communication) or RFID-type (Radio Frequency Identification) electronic chip. An NFC-type radiofrequency peripheral device operates at a frequency of 13.56 MHz as a HF RFID-type radiofrequency peripheral device.

Typically, it is possible to read, in each radiofrequency peripheral device, a unique identifier UID (Unique Identifier Data), which is the serial number of the radiofrequency peripheral device, and/or an information allowing identification of the tag 1. This information allowing identification of the electronic shelf label 1 is definitively attributed to the electronic shelf label 1 during the manufacture of said electronic shelf label 1, thereby constituting an identifier of the electronic shelf label 1. This identifier is definitively stored in the radiofrequency peripheral device.

Due to the one-to-one nature of the relation between a radiofrequency peripheral device and an electronic shelf label 1, and to the uniqueness of the identifier for both the tag and the radiofrequency peripheral device, a radiofrequency peripheral device identifier can identify an electronic shelf label and, vice versa, an electronic shelf label identifier 1 can identify a radiofrequency peripheral device, so that a radiofrequency peripheral device identifier is also a label identifier.

The serial number as well as any information allowing the identification of the electronic shelf label 1 is then called label identifier.

The system comprises a plurality of radiofrequency beacons 4 configured to transmit radio signals. These radiofrequency beacons 4 are distributed in the sales area, preferably at spots allowing good reception of the radio signals for most of the sales area. The radiofrequency beacons 4 are preferably arranged at a height greater than the height of most of the shelves 2 of the sales area. The radiofrequency beacons 4 can thus be arranged for example on the ceiling of the sales area.

Moreover, since a sales area generally includes a plurality of gondolas 2 carrying the electronic shelf labels 1, which define aisles 5 therebetween, radiofrequency beacons 4 can be arranged in the extension of aisles 5 of the sales area. Thus, in the example illustrated in FIG. 1, the extension of each aisle 5 passing between the two shelves 2 defining this aisle 5 is illustrated by a dotted line 50. The radiofrequency beacons 4 have here been placed against the wall, at the ceiling and, as indicated by the fact that the dotted lines 50 pass through the radiofrequency beacons 4, in the extension of the aisles 5.

Preferably, for the majority of aisles 5 of the sales area, a radiofrequency beacon 4 is arranged at each end of the extension of these aisles 5, so that for each aisle 5, the radio signals transmitted by at least one of the two opposite radiofrequency beacons 4 can reach any point of this aisle 5.

Radiofrequency beacons 4 emit pulses over a frequency band greater than 500 MHz according to the Ultra wideband technique, which is a radio modulation technique based on the transmission of pulses of very short duration, often less than a nanosecond. Thus, the bandwidth reaches very high values.

Such a system also comprises a central computer server 6. The central computer server 6 is generally remote, since it is not physically present in the sales area. The central computer server 6 is a hardware computer device that comprises at least one processor, hardware communication interfaces, and memories in which databases are stored.

Among these databases are association data between electronic shelf labels 1 and respective positions of said electronic shelf labels 1. These association data can for example take the form of a link between a shelf identifier of an electronic shelf label 1 and data representative of the position of said electronic shelf label 1, for example the coordinates thereof.

The system also comprises a portable terminal 3. The portable terminal 3 is adapted to acquire an identifier of an electronic shelf label 1 from an electronic shelf label 1. Preferably, the portable terminal 3 can establish a wireless communication, typically by radiofrequency wireless communication, with the electronic shelf label 1 to acquire the label identifier of said electronic shelf label 1. The portable terminal 3 can also establish infrared or visible-light communication with the electronic shelf label 1. The portable terminal 3 can also acquire the identifier of an electronic shelf label by other means, for example by reading a visual representation of the label identifier arranged on the electronic shelf label 1 or displayed by the electronic shelf label, such as a barcode 13.

The portable terminal 3 is provided with a radiofrequency location module, configured to make use of the radio signals coming from the radiofrequency beacons 4 so that the portable terminal 3 can determine data derived from the radio signals by means of said radiofrequency location module. The radiofrequency location module can in particular have one or more antenna(s) dedicated to the reception of the radio signals emitted by the radiofrequency beacons 4.

Each radiofrequency beacon 4 transmits a radio signal for its identification, encoding typically an identifier. This identifier can for example be coded in a pulse train, or correspond to one feature of the radio signal. The radio signals are carriers of time information, and in particular information on their transmission times by their respective radiofrequency beacons 4. Preferably, this time information is in the time of transmission of the radio signals. For example, when the radio signals have pulses or pulse trains, a radiofrequency beacon 4 emits, in a time-isolated manner, a pulse or a pulse train at an emission time. The time information then corresponds to the time of emission of the pulse itself, or to the beginning or the end of the pulse train. This time information could also take an explicit form and be encoded into the radio signals. More generally, the radio signals are considered as including time information when these radio signals allow determining a time, or at least a time difference, when one or several radiofrequency beacon(s) 4 is/are used.

The emissions of these pulses or pulse trains by different radiofrequency beacons 4 are synchronized, so that these radiofrequency beacons 4 simultaneously emit a pulse or a pulse train for identifying each emitting radiofrequency beacon 4.

The central computer server 6 is configured to be able to communicate, typically via a wireless network 60, with the portable terminal 3, in order at least to receive data sent by said portable terminal 3. Communication between the portable terminal 3 and the central computer server 6 can be established by means of any communication network at least partially wireless, in particular via a DECT, WIFI or 3G type wireless network. Thus the communication can be established by passing via the internet network which is connected to the central computer server 6.

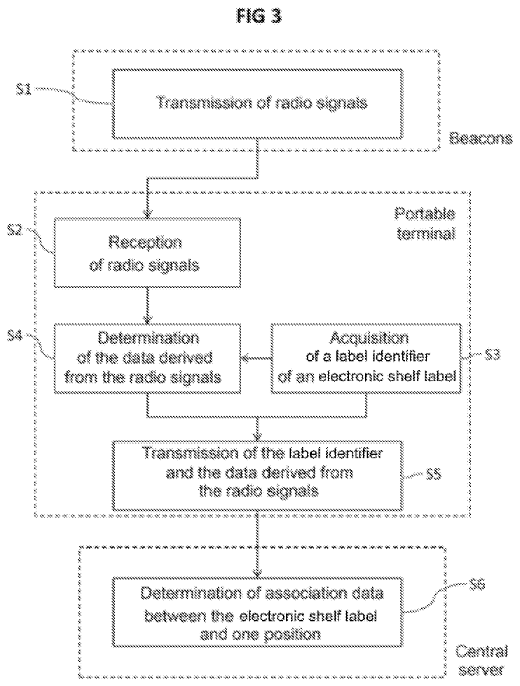

With reference to FIG. 3, the method for locating electronic shelf labels in a sales area comprises a first step (step S1) during which radiofrequency beacons 4 emit radio signals in the sales area. These radio signals are therefore propagated in the sales area, and in particular in the aisles 5 defined between the shelves 2, where people carrying portable terminals 3 are likely to be found. This first step extends for a certain period of time, that is, the radiofrequency beacons 4 transmit radio signals repeatedly, typically at intervals very close to or even less than one second, for a period of time which is greater than one minute. The transmission of signals can for example be controlled at the beginning of the determination of the distribution of a plurality of electronic shelf labels, and then stopped (via a control of the radiofrequency beacons 4).

A portable terminal 3 present in the sales area receives (step S2) then radio signals transmitted by several of said radiofrequency beacons. Depending on the location of the portable terminal 3 in the sales area, the radio signals transmitted by a radiofrequency beacon 4 take more or less time to reach the portable terminal 3. Thus, radio signals transmitted simultaneously by different radiofrequency beacons 4 are received by the portable terminal 3 at different reception times, although sharing the same transmission time. However, the differences between the reception times between radio signals transmitted at the same transmission time by different radiofrequency beacons 4 are small (at least twice smaller) compared to the intervals between two transmission times. Thus, the radio signals received by the portable terminal during a restricted time interval can be considered as having been transmitted at the same transmission time.

To acquire the location of an electronic shelf label 1 (step S3), an operator 7 equipped with a portable terminal 3 approaches said portable terminal 3 of the electronic shelf label 1, so as to be able to acquire the label identifier of the electronic shelf label 1. Typically, this acquisition is made via wireless communication through which the electronic shelf label 1 transmits its label identifier to the portable terminal.

For example, when the electronic tag shelf 1 is provided with a radiofrequency peripheral device, it must be ensured that the radiofrequency peripheral device of the electronic tag shelf 1 is within range of electromagnetic waves emitted by the portable terminal 3. The radiofrequency peripheral device is then activated by the energy of the electromagnetic waves emitted by the portable terminal 3 in order to establish a radiofrequency communication with the radiofrequency peripheral device of the electronic shelf label 1. The radiofrequency peripheral device of the electronic shelf label 1 then in turn emits electromagnetic waves carrying data on the label identifier to the portable terminal 3. The electronic shelf label 1 thus transmits its label identifier to the portable terminal 3 that acquires it then.

Other means for acquiring the label identifier can be implemented. For example, it is possible to provide for a wireless communication that does not use radiofrequency waves, but visible or invisible light waves, such as infrared waves. When the electronic shelf label 1 is provided with an element for visually representing the label identifier, it must be ensured that it is visible by an optical reader of the portable terminal 3, and the portable terminal 3 then reads this label identifier.

The portable terminal 3 can also acquire an item reference of an item 10 associated with the electronic shelf label 1. For example, the portable terminal 3 can read a visual reference of the item 10, such as a barcode. The portable terminal 3 can also read a radiofrequency chip attached to the item 10 if the latter has one. The operator can also enter this item reference on the portable terminal 3 through information input means present on it, such as a keyboard or a touch screen.

As explained above, it can also be provided that the portable terminal 3 does not directly retrieve a tag serial number from the electronic shelf label 1, as for the cases presented above but that the portable terminal 3 retrieves at the electronic shelf label 1, by the above manners, a tag information allowing identification of the electronic shelf label 1. This information allowing the identification of the electronic shelf label 1 is definitively assigned to the tag during the manufacture of said tag, thus constituting an identifier of the tag. This information may for example be composed of a prefix followed by a reference number of the tag forming the label identifier, such as www.SES-imagotag.com/123456789, the suffix “www.SES-imagotag.com” enabling to recognize the information as being likely to be communicated by the portable terminal 3 to a remote server determined by the suffix to retrieve therefrom a serial number of the electronic tag shelf 1. In all cases, the moment when the portable terminal 3 acquires, directly or indirectly, the label identifier from an electronic shelf label 1, constitutes for the portable terminal 3 an acquisition time.

The portable terminal 3 acquires the radio signals received at this acquisition time, using the radiofrequency location module, and determines (step S4) data derived from the radio signals by means of said radiofrequency location module. The portable terminal 3 can determine data derived from the radio signals permanently as long as the reception of the radio signals lasts. Only data derived from radio signals received at the acquisition moment are analyzed or transmitted.

Preferably, while the portable terminal 3 repeatedly picks up and receives over a period of time radio signals coming from radiofrequency beacons 4, the portable terminal 3 does not process the received radio signals except those received at the acquisition time, which allows a considerable saving of resources for the portable terminal 3. The use of these data derived from the radio signals allows locating the portable terminal 3.

The portable terminal 3 transmits (step S5) to the central computer server 6 the label identifier and the data derived from the signals received at the acquisition time. If the item reference of an item 10 associated with the electronic shelf label 1 has been acquired by the portable terminal 3, said item reference can also be transmitted to the central computer server 6 together with the label identifier and the data derived from the radio signals received at the acquisition time. The label identifier, the data derived from the signals received at the acquisition time, and possibly the item reference, are therefore associated by their simultaneous or at least successive transmission.

The central computer server 6 determines (step S6) association data between the electronic shelf label 1 identified by the label identifier and one position of said electronic shelf label 1 determined from the data derived from the radio signals received at the acquisition time.

The position of the electronic shelf label 1 is determined from the position of the portable terminal 3 at the acquisition time. Since the portable terminal 3 is close to the electronic shelf label 1 at this acquisition time, the position of the electronic shelf label 1 is assimilated to the position of the portable terminal 3.

The radiofrequency location module of the portable terminal 3 can itself process the radio signals transmitted by the radiofrequency beacons 4 in order to determine its position, and therefore the one of the electronic shelf label 1. The radiofrequency location module can determine the position the portable terminal 3 from the radio signals transmitted by the radiofrequency beacons 4 by measuring the time of propagation of the respective signals of said radiofrequency beacons 4. For example, the portable terminal 3 can estimate the distance between the portable terminal 3 and each radiofrequency beacon 4 by analyzing time information of the radio signals, by combining them with the times of reception of the radio signals, since each radio signal identifies the radiofrequency beacon that has transmitted it. In particular, with simultaneous transmissions of radio signals by different beacons, the different reception times by the portable terminal 3 make it possible to determine the distances with respect to each radiofrequency beacon. By making use of several radiofrequency beacons 4, it is therefore possible to determine the location of the portable terminal 3, and therefore of the electronic shelf label 1, for example by trilateration or triangulation.

The data derived from the radiofrequency signals are then position data, that is to say data that reflect one position. These position data may be for example position coordinates. These position data are transmitted to the central computer server 6 as data coming from the signals received at the acquisition time.

The data derived from the radiofrequency signals may be reception time measurements of said signals, and the location of the portable terminal 3 is then determined by the central computer server from said time measurements. As explained above for the portable terminal 3, the central computer server 6 can determine the position of the electronic tag shelf 1 from the data derived from the radio signals received at the acquisition time, by comparing together data derived from radio signals coming from different radiofrequency beacons 4.

Other modes for determining the location of the portable terminal 3 may be considered, as an alternative to radiofrequency beacon detection. In particular, the portable terminal 3 may be provided with a positioning module capable of receiving a visible light signal on a frequency between 400 and 800 THz.

In the latter case, the radiofrequency beacons can be replaced by light-emitting diode luminaires or LED luminaires, arranged at known positions in the sales area. A database with which the central server 6 can communicate contains location information of each of the LED luminaires in the sales area. As for radiofrequency beacons, the transmission of light signals can for example be controlled at the beginning of the determination of location of several electronic shelf labels, and then stopped. During step S2, the portable terminal 3 receives a light signal or a series of light signals (Visible Light Communication or VLC code(s)) transmitted by one or more LED luminaire(s), VLC codes making it possible to detect luminaires in a unique way. The positioning module of the portable terminal 3 is configured to recognize the VLC code specific to each LED luminaire, and communicate with the central server 6 for removing the location data of the LED luminaires, so as to determine in step S4 location data of the portable terminal 3.

The wireless communication modalities between the portable terminal 3 and the electronic shelf labels 1, in particular step S3 of acquiring, by the portable terminal 3, a label identifier 3 nearby, are unchanged with respect to the method of FIG. 3. Furthermore, step S5 of communication between the portable terminal 3 and the central server 6 is also preserved.

The association data determined in step S6 for an electronic shelf label 1 indicate that the electronic shelf label 1 in question is at a precise position in the sales area, which can for example be encoded by means of coordinates in a marker, or still preferably, corresponds to a predetermined spot in the sales area. Indeed, the electronic shelf labels 1 are not found anywhere in the sales area, but precisely on the shelves 2 (hence their name) or the like. A set of spots defined in the sales area can thus be arranged, which can be assigned as a position to the electronic shelf labels 1.

Consequently, their location in the sales area can be specified by assigning them the nearest spot. This may for example be the combination of a gondola reference 2, a shelf number 22 and a distance along the rail 21. The reference of a shelf 2 may also correspond to spot information, and for example be composed of an aisle number 5 and an order in this aisle 5.

Whatever solution is adopted to manage the knowledge of the position of an electronic shelf label 1, the association data can take various forms allowing their use. Particularly, it can be provided to know accordingly the spot of each item 10, thanks to the electronic tag shelf 1 associated thereto.

If the item reference has not been acquired by the portable terminal 3, the label identifier can be used to find in a dedicated database the item reference of the item associated with the electronic shelf label 1 identified by the label identifier. Information on the position of each item 10 in the sales area is then also obtained.

The set of association data thus forms a planogram, as indicated above. Thanks to this method, it is thus possible to establish, modify or update the planogram. In particular, any displacement of electronic shelf label 1 in the sales area can immediately be reflected on the planogram, which allows adapting it in real time. The invention thus makes it possible to make of the planogram a faithful representation of the sales area.

1. A method for locating electronic shelf labels (1) in a sales area, said sales area having a plurality of electronic shelf labels (1) distributed in said sales area, each of said electronic shelf labels (1) being associated with an item, each of said electronic shelf labels (1) being provided with a label identifier specific thereto, said sales area comprising a plurality of radiofrequency beacons (4) configured to transmit radio signals (S1),
the expected arrangement of the electronic tags in the sales area being described by a planogram configured to comprise association data between each of a plurality of label identifiers and an expected position within gondolas of the sales area,
said method comprising the following steps:
a portable terminal (3) provided with a radiofrequency location module receives (S2) radio signals transmitted by a plurality of radiofrequency beacons (4) and determines (S4) data derived from the radio signals by means of said radiofrequency location module;
at an acquisition time, the portable terminal (3) acquires (S3) the identifier of an electronic shelf label (1) from said electronic shelf label (1);
the portable terminal (3) transmits (S5) to a central computer server (6) the label identifier and the data derived from the signals received at the acquisition time,
the central computer server (6) determines (S6) association data between the electronic shelf label (1) identified by the label identifier and one position of said electronic shelf label (1) determined from the data derived from the radio signals received at the acquisition time, the position thus determined being specific to said electronic shelf label (1).

2. The method according to claim 1, wherein the portable terminal (3) also acquires an identifier of an item (10) associated with the electronic shelf label (1) and transmits said item identifier to the central computer server (6) as well as the label identifier and the data derived from the radio signals received at the acquisition time, and the central computer server (6) determines association data between the electronic shelf label (1), the position of the electronic shelf label (1) and the item associated with said electronic shelf label (1).

3. The method according to claim 1, wherein the determined position for the electronic shelf label (1) is determined, among predefined spots, as the nearest spot to the portable terminal (3).

4. The method according to claim 3, wherein the determined position for the shelf tag is defined as the combination of a reference of the gondola (2), a number of a shelf (22) and a distance along a rail (21).

5. The method according to claim 1, wherein each electronic tag shelf (1) is provided with a radiofrequency peripheral device and the portable terminal (3) acquires the identifier of the electronic tag shelf (1) by establishing a radiofrequency communication with said electronic shelf label (1).

6. The method according to claim 5, wherein the radiofrequency peripheral device comprises an antenna and an NFC-type (Near Field Communication) electronic chip.

7. The method according to claim 1, wherein each electronic shelf label (1) is provided with an element for visually representing the label identifier, and the portable terminal (3) comprises an optical reader adapted to read said visual representation element and acquire the label identifier.

8. The method according to claim 1, wherein the radiofrequency location module determines the location of the portable terminal (3) from the radio signals transmitted by the radiofrequency beacons (4) by measuring the propagation time of the respective signals of said radiofrequency beacons (4), and the data derived from the radiofrequency signals are position data.

9. The method according to claim 8, wherein the location data are position coordinates.

10. The method according to claim 1, wherein the data derived from the radiofrequency signals are reception time measurements of said signals, and the location of the portable terminal (3) is determined by the central computer server (6) from said time measurements.

11. The method according to claim 1, wherein the sales area includes a plurality of gondolas (2) carrying the electronic shelf labels (1), said gondolas defining aisles (5) therebetween, and radiofrequency beacons (4) are arranged in the extension of aisles (5) of the sales area.

12. The method according to claim 11, wherein for each of a plurality of aisles (5), a radiofrequency beacon (4) is arranged on each side of the extension of the aisle (5).

13. The method according to claim 12, wherein the radiofrequency beacons (4) emit pulses over a frequency band greater than 500 MHz according to the Ultra wideband technique.

14. A method for locating electronic shelf labels (1) in a sales area, said sales area having a plurality of electronic shelf labels (1) distributed in said sales area, each of said electronic shelf labels (1) being associated with an item, each of said electronic shelf labels (1) being provided with a label identifier specific thereto, said sales area comprising a plurality of luminaires (4) configured to transmit light signals (S1),
the expected arrangement of the electronic tags in the sales area being described by a planogram configured to comprise association data between each of a plurality of label identifiers and an expected position within gondolas of the sales area,
said method comprising the following steps:
a portable terminal (3) equipped with a positioning module receives (S2) light signals transmitted by several luminaires (4) and determines (S4) data derived from the light signals by means of said positioning module;
at an acquisition time, the portable terminal (3) acquires (S3) the identifier of an electronic shelf label (1) from said electronic shelf label (1);
the portable terminal (3) transmits (S5) to a central computer server (6) the label identifier and the data derived from the signals received at the acquisition time,
the central computer server (6) determines (S6) the association data in the planogram between the electronic shelf label (1) identified by the label identifier and one position of said electronic shelf label (1) determined from the data derived from the light signals received at the acquisition time, the position thus determined being specific to said electronic shelf label (1).

15. A system for locating electronic shelf labels (1) in a sales area, said sales area having a plurality of electronic shelf labels distributed in said sales area, each of said electronic shelf labels (1) being associated with an item (10), each of said electronic shelf labels being provided with a label identifier specific thereto,
said system comprising:
a central computer server (6), comprising a planogram configured to comprise association data between each of a plurality of label identifiers and an expected position within gondolas of the sales area,
a plurality of radiofrequency beacons configured to transmit radio signals,
a portable terminal (3) provided with a radiofrequency location module configured to receive the radio signals and determine data derived from the radio signals by means of said radiofrequency location module, the portable terminal (3) being further adapted to acquire, at an acquisition time, an identifier of an electronic shelf label (1) from said electronic shelf label (1),
and to transmit to the central computer server the label identifier (6) and the data derived from the signals received at the acquisition time,
the central computer server (6) being configured to determine association data in the planogram between the electronic shelf label (1) identified by the label identifier and one position of said electronic shelf label (1) determined from the data derived from the radio signals received at the acquisition time, the position thus determined being specific to said electronic shelf label (1).

16. The system according to claim 15, wherein the central computer server (6) is configured to determine a position of the electronic shelf label (1) corresponding to the combination of a gondola reference (2), a number of a shelf (22) and a distance along a rail (21).

17. A system for locating electronic shelf labels (1) in a sales area, said sales area having a plurality of electronic shelf labels distributed in said sales area, each of said electronic shelf labels (1) being associated with an item (10), each of said electronic shelf labels being provided with a label identifier specific thereto,
said system comprising:
a central computer server (6), comprising a planogram configured to comprise association data between each of a plurality of label identifiers and an expected position within gondolas of the sales area,
a plurality of radiofrequency beacons configured to transmit radio signals,
a portable terminal (3) provided with a radiofrequency location module configured to receive the radio signals and determine data derived from the radio signals by means of said radiofrequency location module, the portable terminal (3) being further adapted to acquire, at an acquisition time, an identifier of an electronic shelf label (1) from said electronic shelf label (1),
and to transmit to the central computer server the label identifier (6) and the data derived from the signals received at the acquisition time,
the central computer server (6) being configured to determine association data in the planogram between the electronic shelf label (1) identified by the label identifier and one position of said electronic shelf label (1) determined from the data derived from the radio signals received at the acquisition time, the position thus determined being specific to said electronic shelf label (1),
said system being configured to implement the method according to claim 1.

18. A system for locating electronic shelf labels (1) in a sales area, said sales area having a plurality of electronic shelf labels distributed in said sales area, each of said electronic shelf labels (1) being associated with an item (10), each of said electronic shelf labels being provided with a label identifier specific thereto,
said system comprising:
a central computer server (6), comprising a planogram configured to comprise association data between each of a plurality of label identifiers and an expected position within gondolas of the sales area,
a plurality of luminaires configured to transmit light signals,
a portable terminal (3) equipped with a positioning module configured to receive the light signals and determine data derived from the light signals by means of said positioning module, the portable terminal (3) being furthermore adapted to acquire, at an acquisition time, an identifier of an electronic shelf label (1) from said electronic shelf label (1),
and to transmit to the central computer server the label identifier (6) and the data derived from the signals received at the acquisition time,
the central computer server (6) being configured to determine association data in the planogram between the electronic shelf label (1) identified by the label identifier and one position of said electronic shelf label (1) determined from the data derived from the light signals received at the acquisition time, the position thus determined being specific to said electronic shelf label (1).

19. The system according to claim 18, wherein the luminaires comprise light-emitting diodes, and the light signals carry VLC (Visible Light Communications) codes.
